(19) United States
(12) Patent Application Publication
(10) Pub. No.: US 2015/0159683 A1
(43) Pub. Date: Jun. 11, 2015

(54) HINGE STRUCTURE FOR SMALL-SIZED CLIPS

(71) Applicants: Chan-soo KIM, (US); Bum-jin KIM, (US)

(72) Inventors: Chan-soo Kim, Seoul (KR); Bum-Jin Kim, Seoul (KR)

(21) Appl. No.: 14/404,795

(22) PCT Filed: May 28, 2013
(86) PCT No.: PCT/KR2013/004674

§ 371 Date: Dec. 1, 2014

(30) Foreign Application Priority Data
May 29, 2012 (KR) 10-2012-0056590

(51) Int. Cl. F16B 2/10

(52) U.S. Cl. CPC F16B 2/10

(57) ABSTRACT

The present invention relates to a pair of small-sized clips including: an upper clip having a pressing portion, a clip portion, and an upper hinge portion having a shaft hole formed thereon; a lower clip having a pressing portion, a clip portion, and a lower hinge portion having a shaft hole formed thereon; a hinge shaft insertedly coupled to the shaft holes of the upper hinge portion and the lower hinge portion; and a spring fitted to the hinge shaft and elastically supporting the pressing portions against both end portions thereof, the hinge shaft having a head portion, first and second coupling portions formed on the other side of the head portion in such a manner as to be fitted to the shaft holes, and a tapered portion formed on a portion, to which the spring is fitted, between the first and second coupling portions to form a stepped projection on one end thereof.

### BACKGROUND OF THE INVENTION

1. Field of the Invention

The present invention relates to a pair of small-sized clips which performs a pickup operation by using the elasticity of a spring, and more particularly, to a pair of small-sized clips which has a hinge shaft and a spring made in a novel form, so that no additional process is needed when the hinge shaft is coupled, thus shortening a manufacturing process and remarkably improving production efficiencies through the reduction in the number of components thereof.

2. Background of the Related Art

As widely known, a pair of small-sized clips is used particularly as hair clips.

Conventional small-sized clips will be explained with reference to FIGS. 1 and 2.

As shown in FIG. 1, the conventional small-sized clips includes an upper clip 10, a lower clip 20, a rivet 31 shaft-coupled between an upper hinge portion 11 of the upper clip 10 and a lower hinge portion 21 of the lower clip 20, and a spring 32 fitted to the rivet 31 to elastically support a pressing portion 13 of the upper clip 20 and a pressing portion 23 of the lower clip 20.

Under the above structure, the pressing portion 13 of the upper clip 20 and the pressing portion 23 of the lower clip 20 are pressed to open pressurizing portions 14 and 24, and after a desired object is picked up, next, the pressing force applied to the pressing portions 13 and 23 is released to strongly hold the desired object through the clips. If the clips are used as hair clips, hair can be firmly fixed to the clips.

On the other hand, an explanation on a manufacturing process for the small-sized clips performing the above-mentioned function will be given.

First, the upper hinge portion 11 of the upper clip 10 and the lower hinge portion 21 of the lower clip 20 are coupled to each other to allow the shaft holes 12 and 22 to be located correspondingly to each other. Next, the spring 32 is inserted into the space between the upper hinge portion 11 and the lower hinge portion 12, and the rivet 31 as a hinge shaft is inserted into one side shaft holes 12 and 22, passed through the spring 32, and finally fitted to the other side shaft holes 12 and 22.

After that, the clips having the spring 32 and the rivet 31 coupled thereto is located to one side, as shown in FIG. 2, and a fastener 33 is placed on the end portion of the rivet 31 and hits by a tool, thus completing the fixing process of the rivet 31.

According to the manufacturing method of the conventional clips, by the way, after the rivet 31 is fastened to the shaft holes 12 and 22, an additional process for fixing the fastener 33 to the rivet 31 is needed, thus undesirably increasing the number of manufacturing processes, and further, the operating for hitting the fastener 33 by using a tool makes workers uncomfortable.

If the operating for hitting the fastener 33 is mistakenly performed, scratches may be formed on the finished products, which causes the products to be thrown away.

### SUMMARY OF THE INVENTION

Accordingly, the present invention has been made in view of the above-mentioned problems occurring in the prior art, and it is an object of the present invention to provide a pair of small-sized clips which has a hinge shaft and a spring made in a novel form, so that no additional process is needed when the hinge shaft is coupled, thus shortening a manufacturing process and remarkably improving production efficiencies through the reduction in the number of components thereof.

To accomplish the above-mentioned object, according to the present invention, there is provided a pair of small-sized clips including: an upper clip having a pressing portion, a clip portion, and an upper hinge portion having a shaft hole formed thereon; a lower clip hingedly coupled to the upper clip and having a pressing portion, a clip portion, and a lower hinge portion having a shaft hole formed thereon; a hinge shaft insertedly coupled to the shaft holes of the upper hinge portion and the lower hinge portion; and a spring fitted to the hinge shaft and elastically supporting the pressing portion of the upper clip and the pressing portion of the lower clip against both end portions thereof, wherein the hinge shaft includes: a head portion; a first coupling portion and a second coupling portion formed on the other side of the head portion in such a manner as to be fitted to the shaft holes; and a tapered portion taperedly formed on a portion, to which the spring is fitted, between the first coupling portion and the second coupling portion in such a manner as to form a stepped projection on one end thereof.

According to the present invention, desirably, the hinge shaft includes: a first coupling portion and a second coupling portion formed on both ends thereof in such a manner as to be fitted to the shaft holes of the upper clip and the lower clip; and a small diameter portion formed on a portion, to which the spring is fitted, between the first coupling portion and the second coupling portion in such a manner as to form stepped projections on both ends thereof.

According to the present invention, desirably, the hinge shaft includes: a first coupling portion and a second coupling portion formed on both ends thereof in such a manner as to be fitted to the shaft holes of the upper clip and the lower clip; and an incised portion formed on a portion, to which the spring is fitted, between the first coupling portion and the second coupling portion in such a manner as to form partial stepped projections on both ends thereof.

According to the present invention, desirably, the hinge shaft includes: a first coupling portion and a second coupling portion formed on both ends thereof in such a manner as to be fitted to the shaft holes of the upper clip and the lower clip; and incised portions formed on top and underside of a portion, to which the spring is fitted, between the first coupling portion and the second coupling portion in such a manner as to form partial stepped projections on both ends thereof.

According to the present invention, desirably, the hinge shaft includes: a first coupling portion and a second coupling portion formed on both ends thereof in such a manner as to be fitted to the shaft holes of the upper clip and the lower clip; and locking groove portions formed on both ends of a portion, to which the spring is fitted, between the first coupling portion and the second coupling portion.

According to the present invention, desirably, the upper clip has an upper locking protrusion formed on one side of the inner surface of the pressing portion thereof, and the lower clip has a lower locking protrusion formed on one side of the inner surface of the pressing portion thereof, so that both side end portions of the spring are fixed to the upper locking protrusion and the lower locking protrusion.

According to the present invention, desirably, the spring has one side end portion and the other side end portion supporting the pressing portions of the upper clip and the lower clip, one side end portion and the other side end portion having different lengths from each other.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view showing conventional small-sized clips;

FIG. 2 is a perspective view showing a process for fastening a rivet to the clips of FIG. 1;

FIG. 3 is an exploded perspective view showing a pair of small-sized clips according to a first embodiment of the present invention;

FIG. 4 is a perspective view showing the pair of small-sized clips according to the first embodiment of the present invention;

FIG. 5 is a perspective view showing a hinge shaft of the pair of small-sized clips according to the first embodiment of the present invention;

FIG. 6 is a perspective view showing the coupled relation between the hinge shaft and the spring according to the first embodiment of the present invention;

FIG. 7 is a sectional view showing the coupled relation between the hinge shaft and the spring according to the first embodiment of the present invention;

FIGS. 8a and 8b are perspective and side sectional views showing another coupled relation between the hinge shaft and the spring according to the first embodiment of the present invention;

FIGS. 9a and 9b are perspective and side sectional views showing a hinge shaft in a pair of small-sized clips according to a second embodiment of the present invention;

FIGS. 10a and 10b are perspective and side sectional views showing a hinge shaft in a pair of small-sized clips according to a third embodiment of the present invention;

FIGS. 11a and 11b are perspective and side sectional views showing a hinge shaft in a pair of small-sized clips according to a fourth embodiment of the present invention;

FIGS. 12a and 12b are perspective and side sectional views showing a hinge shaft in a pair of small-sized clips according to a fifth embodiment of the present invention;

FIGS. 13a and 13b are perspective and side sectional views showing a hinge shaft in a pair of small-sized clips according to a sixth embodiment of the present invention; and

FIG. 14 is a perspective view showing another example of the spring having different elastic directions.

### DETAILED DESCRIPTION OF THE PREFERRED EMBODIMENTS

Hereinafter, an explanation on a pair of small-sized clips according to the present invention will be in detail given with reference to the attached drawing.

FIG. 3 is an exploded perspective view showing a pair of small-sized clips according to a first embodiment of the present invention, and FIG. 4 is a perspective view showing the pair of small-sized clips according to the first embodiment of the present invention.

As shown, a pair of small-sized clips according to the first embodiment of the present invention includes: an upper clip 10 having a pressing portion 13, a clip portion 14, and an upper hinge portion 11 having a shaft hole 12 formed thereon, a lower clip 20 hingedly coupled to the upper clip 10 and having a pressing portion 23, a clip portion 24, and a lower hinge portion having a shaft hole 22 formed thereon; a hinge shaft 100 insertedly coupled to the shaft holes 12 and 22 of the upper hinge portion 11 and the lower hinge portion 21; and a spring 200 fitted to the hinge shaft and elastically supporting the pressing portion 13 of the upper clip 10 and the pressing portion 23 of the lower clip 20 against both end portions 201 and 202 thereof.

As shown in FIG. 5, the hinge shaft 100 includes: a head portion 101; a first coupling portion 102 and a second coupling portion 103 formed on the other side of the head portion 101 in such a manner as to be fitted to the shaft holes 12 and 22; and a tapered portion 104 taperedly formed on a portion, to which the spring 200 is fitted, between the first coupling portion 102 and the second coupling portion 103 in such a manner as to form a stepped projection 105 on one end thereof.

One of main features of the pair of small-sized clips according to the first embodiment of the present invention is the formation of the stepped projection 105 on the hinge shaft 100.

Referring to a method for manufacturing the pair of small-sized clips according to the first embodiment of the present invention, the upper hinge portion 11 of the upper clip and the lower hinge portion 21 of the lower clip 20 are coupled to each other to allow the shaft holes 12 and 22 to be located correspondingly to each other.

Next, the spring 200 is inserted into the space between the upper hinge portion 11 and the lower hinge portion 12, and the hinge shaft 100 is inserted into the shaft holes 12 and 22, thus completing the manufacturing process of the small-sized clips.

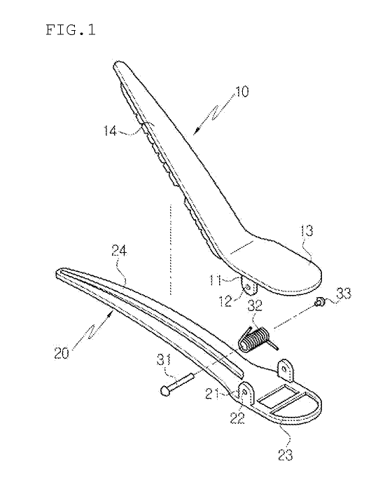

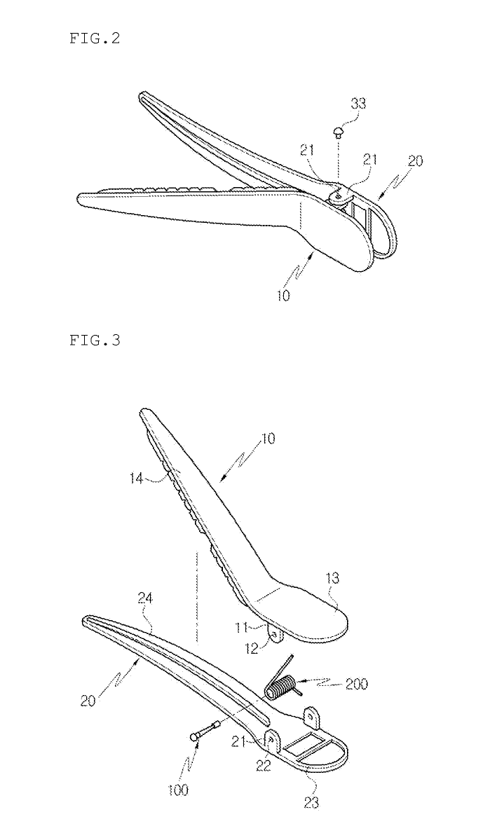

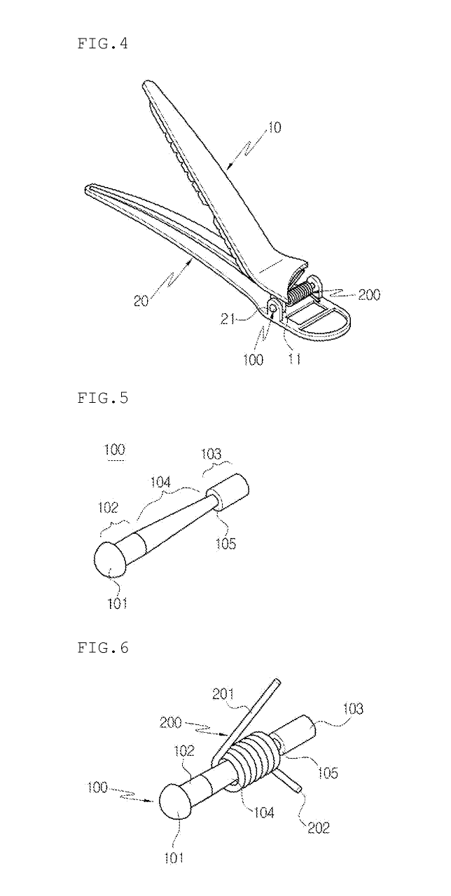

According to the first embodiment of the present invention, the conventional rivet fastening process wherein the rivet 31 (See FIG. 1) is fastened to the shaft holes 12 and 22 and the finishing process is conducted by using the fastener 33 (See FIG. 1) is avoided.

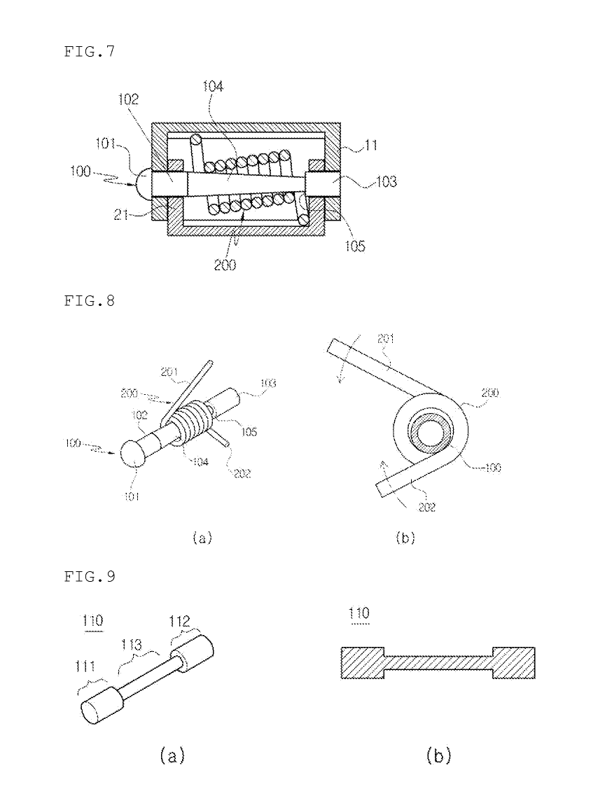

According to the first embodiment of the present invention, accordingly, the spring 200 fitted surroundingly to the hinge shaft 100 is a little twistedly fastened with respect to the hinge shaft 100, as shown in FIG. 7, so that the side portion of the spring 200 in which one side end portion 202 of the spring 200 is disposed is raised and locked onto the stepped projection 105 of the hinge shaft 100.

This is generally generated because of both end portions 201 and 202 of the spring 200, that is, because of different positions of both end portions 201 and 202 and a difference in the forces supporting the respective pressing portions 13 and 23 thereagainst.

Like this, the stepped projection 105 formed on one side of the hinge shaft 100 is locked onto one side of the spring 200, and the head portion 101 formed on the other side of the hinge shaft 100 prevents the hinge shaft 100 from moving in left and right sides, so that the hinge shaft 100 cannot be escaped from the shaft holes 12 and 22.

While the clips are being used, accordingly, it applies given elasticity through the operation of the pressing portions 13 and 23, and at the same time, the hinge shaft 100 is not escaped from the shaft holes 12 and 22.

According to another example of the spring 200, as shown in FIG. 8a, the spring 200 has one side end portion 201 and the other side end portion 202 supporting the pressing portions 13 and 23 of the upper clip 10 and the lower clip 20, and in this case, one side end portion 201 and the other side end portion 202 have different lengths from each other.

Under the above configuration, as shown in FIG. 8b, an upward elastic force generated from the other side end portion 202 having a relatively shorter length than one side end portion 201 is larger than a downward elastic force generated from one side end portion 201, so that an upwardly moving force of the side portion of the spring 200 in which the other side end portion 202 having a relatively shorter length than one side end portion 201 is disposed becomes more increased than a downwardly moving force of the side portion of the spring 200 in which one side end portion 201 is disposed.

Accordingly, the side portion of the spring 200 in which the other side end portion 202 is disposed comes into tighter contact with the stepped projection 105 of the hinge shaft 100.

FIGS. 9a and 9b are perspective and side sectional views showing a hinge shaft in a pair of small-sized clips according to a second embodiment of the present invention.

As shown, a hinge shaft 110 according to the second embodiment of the present invention includes: a first coupling portion 111 and a second coupling portion 112 formed on both ends thereof in such a manner as to be fitted to the shaft holes 12 and 22 of the upper clip 10 and the lower clip 20; and a small diameter portion 113 formed on a portion, to which the spring 200 is fitted, between the first coupling portion 111 and the second coupling portion 112 in such a manner as to form stepped projections on both ends thereof.

Under the above structure, both ends of the spring 200 are locked onto both end stepped projections of the hinge shaft 110 at the time of coupling the hinge shaft 110 to the spring 200, so that the hinge shaft 110 is firmly supported, without any escape from the shaft holes 12 and 22. Accordingly, the hinge shaft 110 according to the second embodiment of the present invention does not have any head portion 101.

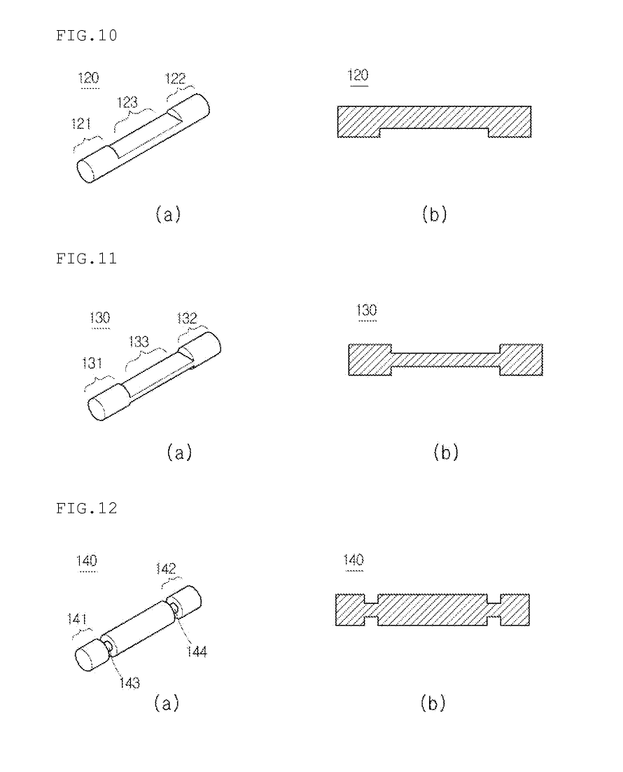

FIGS. 10a and 10b are perspective and side sectional views showing a hinge shaft in a pair of small-sized clips according to a third embodiment of the present invention.

As shown, a hinge shaft 120 according to the third embodiment of the present invention includes: a first coupling portion 111 and a second coupling portion 112 formed on both ends thereof in such a manner as to be fitted to the shaft holes 12 and 22 of the upper clip 10 and the lower clip 20; and an incised portion 123 formed on a portion, to which the spring 200 is fitted, between the first coupling portion 111 and the second coupling portion 112 in such a manner as to form partial stepped projections on both ends thereof.

Under the above structure, both ends of the spring 200 are locked onto both end stepped projections formed through the incised portion 123 of the hinge shaft 120 at the time of coupling the hinge shaft 120 to the spring 200, so that the hinge shaft 120 is firmly supported, without any escape from the shaft holes 12 and 22.

FIGS. 11a and 11b are perspective and side sectional views showing a hinge shaft in a pair of small-sized clips according to a fourth embodiment of the present invention.

As shown, a hinge shaft 130 according to the fourth embodiment of the present invention includes: a first coupling portion 111 and a second coupling portion 112 formed on both ends thereof in such a manner as to be fitted to the shaft holes 12 and 22 of the upper clip 10 and the lower clip 20; and incised portions 133 formed on top and underside of a portion, to which the spring 200 is fitted, between the first coupling portion 111 and the second coupling portion 112 in such a manner as to form partial stepped projections on both ends thereof.

Under the above structure, both ends of the spring 200 are locked onto both end stepped projections formed through the incised portions 133 of the hinge shaft 130 at the time of coupling the hinge shaft 130 to the spring 200, so that the hinge shaft 130 is firmly supported, without any escape from the shaft holes 12 and 22.

FIGS. 12a and 12b are perspective and side sectional views showing a hinge shaft in a pair of small-sized clips according to a fifth embodiment of the present invention.

As shown, a hinge shaft 140 according to the fifth embodiment of the present invention includes: a first coupling portion 111 and a second coupling portion 112 formed on both ends thereof in such a manner as to be fitted to the shaft holes 12 and 22 of the upper clip 10 and the lower clip 20; and locking groove portions 143 and 144 formed on both ends of a portion, to which the spring 200 is fitted, between the first coupling portion 111 and the second coupling portion 112.

Under the above structure, both ends of the spring 200 are locked onto the locking groove portions 143 and 144 of the hinge shaft 140 at the time of coupling the hinge shaft 140 to the spring 200, so that the hinge shaft 140 is firmly supported, without any escape from the shaft holes 12 and 22.

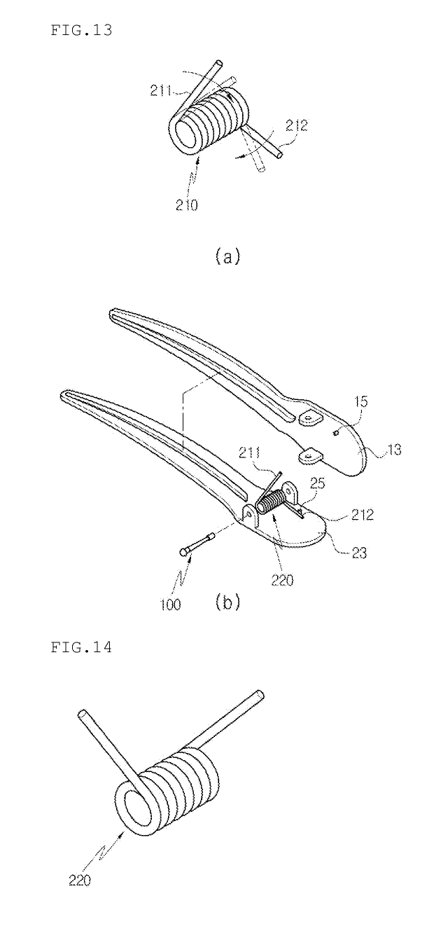

FIGS. 13a and 13b are perspective and side sectional views showing a hinge shaft in a pair of small-sized clips according to a sixth embodiment of the present invention.

As shown in FIG. 13a, both side end portions 211 and 212 of a spring 210 are contracted inwardly, and next, as shown in FIG. 13b, they are fixed to an upper locking protrusion 15 formed on one side of the inner surface of the pressing portion 13 of the upper clip 10 and to a lower locking protrusion 25 formed on one side of the inner surface of the pressing portion 23 of the lower clip 20.

If the spring 210 is completely fixed, like this, the spring 210 is twistedly fastened more rigidly with respect to the hinge shaft 100 by means of the elastic forces of both side end portions 211 and 212 thereof, and the operating effect of the spring 210 is of course the same as mentioned above.

As shown in FIG. 14, of course, the small-sized clips according to the present invention may have a spring 220 having elastic directions different from the springs 200 and 210.

As described above, the pair of small-sized clips according to the present invention has the hinge shaft and the spring made in a novel form, so that no additional process is needed when the hinge shaft is coupled, thus shortening a manufacturing process and remarkably improving production efficiencies through the reduction in the number of components thereof.

According to the present invention, further, no process for fastening the fastener to the rivet is needed anymore, thus removing the inconveniences of the worker.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A pair of small-sized clips comprising:
an upper clip 10 having a pressing portion 13, a clip portion 14, and an upper hinge portion 11 having a shaft hole 12 formed thereon;
a lower clip 20 hingedly coupled to the upper clip 10 and having a pressing portion 23, a clip portion 24, and a lower hinge portion 21 having a shaft hole 22 formed thereon;
a hinge shaft 100 insertedly coupled to the shaft holes 12 and 22 of the upper hinge portion 11 and the lower hinge portion 21; and
a spring 200 fitted to the hinge shaft 100 and elastically supporting the pressing portion 13 of the upper clip 10 and the pressing portion 23 of the lower clip 20 against both end portions 201 and 202 thereof,
wherein the hinge shaft 100 comprises:
a head portion 101;
a first coupling portion 102 and a second coupling portion 103 formed on the other side of the head portion 101 in such a manner as to be fitted to the shaft holes 12 and 22; and
a tapered portion 104 taperedly formed on a portion, to which the spring 200 is fitted, between the first coupling portion 102 and the second coupling portion 103 in such a manner as to form a stepped projection 105 on one end thereof.

2. The small-sized clips according to claim 1, wherein the hinge shaft comprises: a first coupling portion 111 and a second coupling portion 112 formed on both ends thereof in such a manner as to be fitted to the shaft holes 12 and 22 of the upper clip 10 and the lower clip 20; and a small diameter portion 113 formed on a portion, to which the spring 200 is fitted, between the first coupling portion 111 and the second coupling portion 112 in such a manner as to form stepped projections 105 on both ends thereof.

3. The small-sized clips according to claim 1, wherein the hinge shaft comprises: a first coupling portion 111 and a second coupling portion 112 formed on both ends thereof in such a manner as to be fitted to the shaft holes 12 and 22 of the upper clip 10 and the lower clip 20; and an incised portion 123 formed on a portion, to which the spring 200 is fitted, between the first coupling portion 111 and the second coupling portion 112 in such a manner as to form partial stepped projections on both ends thereof.

4. The small-sized clips according to claim 1, wherein the hinge shaft comprises: a first coupling portion 111 and a second coupling portion 112 formed on both ends thereof in such a manner as to be fitted to the shaft holes 12 and 22 of the upper clip 10 and the lower clip 20; and incised portions 133 formed on top and underside of a portion, to which the spring 200 is fitted, between the first coupling portion 111 and the second coupling portion 112 in such a manner as to form partial stepped projections on both ends thereof.

5. The small-sized clips according to claim 1, wherein the hinge shaft comprises: a first coupling portion 111 and a second coupling portion 112 formed on both ends thereof in such a manner as to be fitted to the shaft holes 12 and 22 of the upper clip 10 and the lower clip 20; and locking groove portions 143 and 144 formed on both ends of a portion, to which the spring 200 is fitted, between the first coupling portion 111 and the second coupling portion 112.

6. The small-sized clips according to claim 1, wherein the upper clip 10 has an upper locking protrusion 15 formed on one side of the inner surface of the pressing portion 13 thereof, and the lower clip 20 has a lower locking protrusion 25 formed on one side of the inner surface of the pressing portion 23 thereof, so that both side end portions 211 and 212 of a spring 210 are fixed to the upper locking protrusion 15 and the lower locking protrusion 25.

7. The small-sized clips according to claim 1, wherein the spring 200 has one side end portion 201 and the other side end portion 202 supporting the pressing portions 13 and 23 of the upper clip 10 and the lower clip 20, one side end portion 201 and the other side end portion 202 having different lengths from each other.
